(19) United States
(12) Patent Application Publication
(10) Pub. No.: US 2016/0122649 A1
(43) Pub. Date: May 5, 2016

(54) MODIFICATION OF RHEOLOGICAL PROPERTIES OF THERMOTROPIC LIQUID CRYSTALLINE POLYMERS FOR MANUFACTURING FILM PRODUCTS

(71) Applicant: BOARD OF REGENTS, THE UNIVERSITY OF TEXAS SYSTEM, Austin, TX (US)

(72) Inventors: Christopher J. Ellison, Austin, TX (US); Zhenpeng Li, Austin, TX (US)

(73) Assignee: Board of Regents, The University of Texas System, Austin, TX (US)

(21) Appl. No.: 14/889,286

(22) PCT Filed: May 13, 2014
(86) PCT No.: PCT/US2014/037896

§ 371 Date: Nov. 5, 2015

Related U.S. Application Data
(60) Provisional application No. 61/822,701, filed on May 13, 2013.

(51) Int. Cl. C09K 19/38; C08L 67/04; C08L 23/12; C08G 63/91; C08G 69/48

(52) U.S. Cl. CPC C09K 19/3838; C08G 63/912; C08G 69/48; C08L 23/12; C08L 67/04

(57) ABSTRACT

In some embodiments, a compound and/or method of making a compound includes the modification of rheological properties of thermotropic main chain liquid crystalline polymers (LCPs) by melt state reactive processing. The modified liquid crystalline polymer may have an increased viscosity while retaining its liquid crystal properties.

### STATEMENT REGARDING FEDERALLY SPONSORED RESEARCH OR DEVELOPMENT

This invention was made with government support from the NSF STC Center for Layered Polymeric Materials, Grant number DMR-0423914. The U.S. Government has certain rights to this invention.

### BACKGROUND OF THE INVENTION

1. Field of the Invention

The invention generally relates to modified liquid crystal polymers and polymer composites made from modified liquid crystal polymers.

2. Description of the Relevant Art

Liquid crystalline polymers (LCPs) possess much lower permeability than other conventional barrier materials such as polyethylene terephthalate (PET) and Nylon. It would be valuable to implement LCPs into film products by (co)extrusion to make multilayer films, especially if the layers could be made very thin (i.e., less than 1 micron) to compensate for the expense of LCPs compared to conventional polymers. These LCP film products could come close to competing with metalized film which is very expensive in film applications.

However, it is well known that the viscosities of LCPs are very low when compared to other conventional polymers. Such low viscosities present a challenge in implementing LCPs into film extrusion. For example, multilayer coextrusion with other polymers requires the viscosity of two components to be closely matched in order to make high quality multilayer films. Therefore, a method to enhance the rheological properties (viscosity and elasticity) of LCPs while not affecting their intrinsic liquid crystal structures is important.

One approach for enhancing the melt viscosities of LCPs is to form composites, especially with short fibers and other inorganic fillers. The rheological properties of carbon fillers (e.g., graphite, carbon black and carbon fiber) with Vectra A950RX composites showed that both carbon black fillers and carbon fibers can significantly increase the viscosity. Other kinds of fibers, such as glass fibers, have also been employed to modify the mechanical properties of LCPs. Although forming composites can improve the rheological and mechanical properties of LCPs, the presence of fillers can affect the unique properties of the LCP on macroscopic and microscopic length scales. Addition of micro-scale fillers can also affect optical clarity. Since many applications of LCPs are highly dependent on their unique liquid crystal structures, a method which can modify the rheological properties without affecting the intrinsic micro- or macro-scale structures or optical clarity, would be very attractive.

Triphenyl phosphite (TPP) has also been used to modify the rheological properties of a thermotropic main chain liquid crystalline polymer Vectra A950. However, the modified liquid crystal polymer samples are not stable when melt reprocessed in air due to hydrolysis from ambient water in the air during high temperature processing. This makes this approach with TPP not useful since reprocessing is necessarily required to make the film from the modified polymer resin. In addition, most extrusion processes are performed in air not inert gas.

### SUMMARY

In some embodiments, a compound and/or method of making a compound includes the modification of rheological properties of thermotropic main chain liquid crystalline polymers (LCPs) by melt state reactive processing. The modified liquid crystalline polymer may have an increased viscosity while retaining its liquid crystal properties.

### BRIEF DESCRIPTION OF THE DRAWINGS

Advantages of the present invention may become apparent to those skilled in the art with the benefit of the following detailed description of the preferred embodiments and upon reference to the accompanying drawings.

FIG. 1 depicts the steady shear viscosity at 0.1 s⁻¹ shear rate at 220° C. for V400p samples compounded with 0 (⋄), 0.5 ( ), 1 (Δ), and 1.5 (x) wt % Heloxy 67 as a function of mixing time.

FIG. 2 depicts polarized optical microscopy (POM) images of Vectra V400p compounded with (a) 0 wt % and (b) 1.5 wt % Heloxy 67.

FIG. 3 depicts DSC thermograms of Vectra V400p compounded with 0 wt % and 1.5 wt % Heloxy 67 taken upon second heating at a rate of 5° C./min.

FIG. 4 depicts the Melt Flow Index (MFI) viscosity (i.e., a viscosity derived from a melt flow index measurement) of modified Vectra V400p and PP-g-MA.

FIG. 5 depicts photos of (a) neat Vectra V400p/PP-g-MA and (b) modified Vectra V400p/PP-g-MA multilayer films.

FIG. 6 depicts cross section SEM images of (a) neat Vectra V400p/PP-g-MA and (b, c, d) modified Vectra V400p/PP-g-MA multilayer films.

FIG. 7 depicts consecutive SEM images of multilayer films showing the continuity of LCP layers over large distances. Each image is roughly 30 microns wide.

FIG. 8 depicts a schematic diagram showing the gas diffusion pathway through the oriented liquid crystal (LC) domains.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third die electrically connected to the module substrate” does not preclude scenarios in which a “fourth die electrically connected to the module substrate” is connected prior to the third die, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

It is to be understood the present invention is not limited to particular devices or biological systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “a linker” includes one or more linkers.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

In an embodiment, the viscosity of a liquid crystal polymer material may be improved by reacting a liquid crystal polymer with an epoxy containing compound. The epoxy compound reacts with functional groups of the liquid crystal polymer to create a modified liquid crystal polymer, which has an increased viscosity without substantially altering its liquid crystal properties. In some embodiments, the liquid crystal polymer is a thermotropic liquid crystal polymer.

Thermotropic liquid crystal polymers that may be modified include poly (hydroxybenzoate-hydroxynaphthoate) copolymers (e.g., VECTRA liquid crystal polymers) and poly (paraphenylene terephthalamide) (aramid polymers, e.g., Kevlar). Poly (hydroxybenzoate-hydroxynaphthoate) copolymers include both hydroxy and carboxylic acid functional groups which can react with epoxy groups to covalent bond with the epoxy-containing modifier. Aramid polymers include an amine group which can react with epoxy groups to covalent bond with the epoxy-containing modifier.

The epoxy containing modifying compound may be a diepoxy compound. The diepoxy compound may be an aliphatic glycidyl ether diepoxy compound or an aromatic aliphatic glycidyl ether diepoxy compound. Suitable epoxy containing modifiers are sold under the tradename of HELOXY by Momentive Specialty Chemicals, Houston Tex. Other epoxy compounds with different functionailities may be effective for the same purposes, for instance, modifiers sold under the trade name Epon (also by Momentive) and triglycidyl isocyanurate (TGIC). In some embodiments, at least a di-functional compound (e.g., a di-epoxy compound, a tri-epoxy compound, etc.) may be reacted with a LCP.

The modified liquid crystal polymer may be formed by forming a mixture of a liquid crystal polymer with an epoxy containing compound. The mixture may be heated to a temperature at or above the glass transition temperature and/or melt transition temperature of the liquid crystal polymer. Heating the mixture initiates the reaction between the reactive functional groups of the polymer and the epoxy groups of the epoxy containing compound. The covalently modified liquid crystal polymers exhibit increased viscosity, while substantially retaining most, it not all of their liquid crystal properties. The weight percent of epoxy containing material added to the liquid crystal material affects the viscosity of the resulting modified liquid crystal material. The higher the weight percentage of epoxy containing material, the higher the viscosity of the resulting material. Typical weight percentages of epoxy containing material added to a liquid crystal polymer are between 0.1% to about 10%, between 0.25% and 5%, and between 0.5% and 2%.

In some embodiments, the mixture is heated in an extrusion device and extruded after heating. The resulting extruded mixture may be formed into pellets or any other shape suitable for use during production of a polymer composite. After the modified liquid crystal material is formed, the compound may be dried under vacuum, with or without additional heat.

The modified liquid crystal polymer may be used to form a polymer composite that includes the modified liquid crystal polymer and a thermoplastic polymer. The thermoplastic polymer may be any polymer that can be processed by melt processing. In one embodiment, the thermoplastic polymer is a polypropylene polymer. The thermoplastic polymer preferably has a viscosity, at the melt processing temperature, equal to or similar to the viscosity of the modified liquid crystal polymer at the melt processing temperature. In some embodiments, the viscosity of the thermoplastic polymer at melt processing temperatures is within 25%, within 10% or within 5% of the viscosity of the modified polymer at the melt processing temperature. Matching the viscosities of the liquid crystal polymer and the thermoplastic polymer during processing minimizes the defects and holes typically present when polymers of different viscosities are processed.

The polymer composite may be formed from multiple layers of thermoplastic polymer and the modified liquid crystal polymer. The layers may be alternating layers of the two materials.

The polymer composite may be made by heating the modified liquid crystal polymer at or above the glass transition temperature and/or melt transition temperature of the liquid crystal polymer and heating the thermoplastic polymer at or above the glass transition temperature and/or melt transition temperature of the thermoplastic polymer. The two components of the polymer composite may be co-extruded to form the polymer composite. The compounds may be extruded as a film. In one embodiment, the components are extruded as a laminar film that includes layers of the thermoplastic polymer and layers of the liquid crystal polymer composition.

Polymer composites that are formed as films are useful due to the liquid crystal polymers intrinsically low gas and liquid permeation rates. Liquid crystal polymer composite films are useful for high barrier films for food packaging and encapsulating oxygen sensitive devices such as organic light emitting diodes and other organic electronic devices (organic solar cells, etc.).

Modified liquid crystal polymers may also be used to develop well-dispersed liquid crystalline polymer blends because the morphology of polymer blending is typically dependent on the viscosity ratio of the two components, i.e., the well-dispersed morphology can be only achieved at certain viscosity ratios. Since the disclosed methodology can modify the viscosity of liquid crystalline polymers, the morphology of liquid crystalline polymers in polymer blending can be controlled.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Materials

Vectra V400p is a commercially available main chain liquid crystalline polymer with a glass-to-liquid crystal transition temperature of around 110° C. and is available from Ticona/Celanese. Vectra V400p was dried at 80° C. under vacuum for more than 24 hours and stored at 60° C. before any melt processing and rheology experiments. The diepoxy reagent Heloxy 67 (Momentive Specialty Chemicals, Inc) was used as received.

### Processing Methods

Roughly 3 grams of Vectra V400p, previously dried at 80° C. in a vacuum oven for more than 24 hours, and Heloxy 67 were added into a DSM microcompounder, which could be reasonably sealed by closing the hopper plunger. The mixing temperature was 230° C. with a rotor speed of 100 rpm. The initial mixing process was performed in nitrogen atmosphere by purging with extra dry nitrogen gas.

Different amounts of Heloxy 67 were added during the process. Heloxy 67 concentrations are always reported in weight of additive per weight of base polymer. In all experiments, the zero time corresponds to the first point of addition of the polymer-Heloxy mixtures into the microcompounder. The products (reacted Vectra+Heloxy) were extruded, cut into pellets, and dried under vacuum at 80° C. for about 12 hours. The terms, “pure” or “neat” Vectra will, herein, refer to Vectra that has not been processed in the microcompounder, while the designation of Vectra with 0 wt % Heloxy means the sample has been microcompounded at temperature in the absence of Heloxy.

As shown below, Heloxy can react with the hydroxyl and carboxyl end groups of V400p which could lead to the coupling of several polymer chains and eventually result in the enhancement of the rheological properties (increased viscosity and elasticity) of V400p.

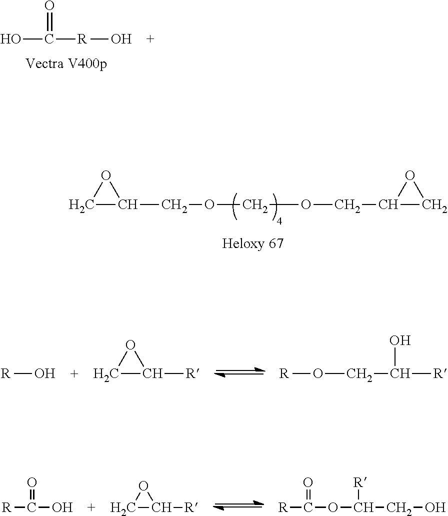

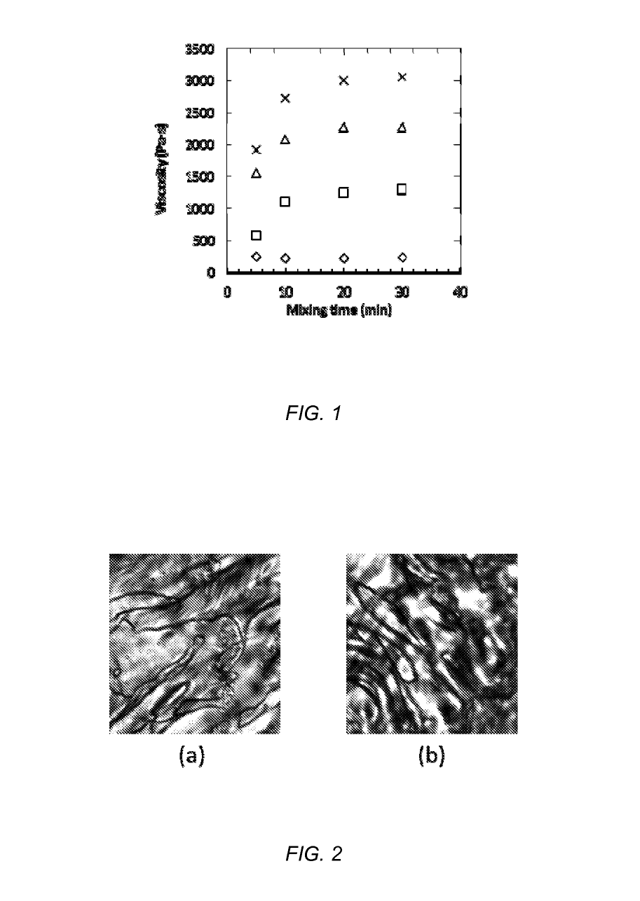

FIG. 1 depicts the steady shear viscosity at 0.1 s⁻¹ shear rate at 220° C. for V400p samples compounded with 0 (⋄), 0.5 ( ) 1 (Δ), and 1.5 (x) wt % Heloxy 67 as a function of mixing time. As shown in FIG. 1, the viscosity of V400p was greatly enhanced by reacting with the Heloxy compound. Furthermore, Heloxy is a very effective reagent, resulting in up to a 15 times increase in viscosity by reacting with 1.5 wt % Heloxy for 20 mins. The reaction between the Heloxy and V400p reaches equilibrium at around 20 mins.

FIG. 2 shows polarized optical microscopy (POM) images of Vectra V400p compounded with (a) 0 wt % and (b) 1.5 wt % Heloxy 67. Microscopy images are taken at 250° C. The results from the polarized optical microscopy (POM) confirmed that the V400p samples still exhibit a liquid crystal state after the reactive modification.

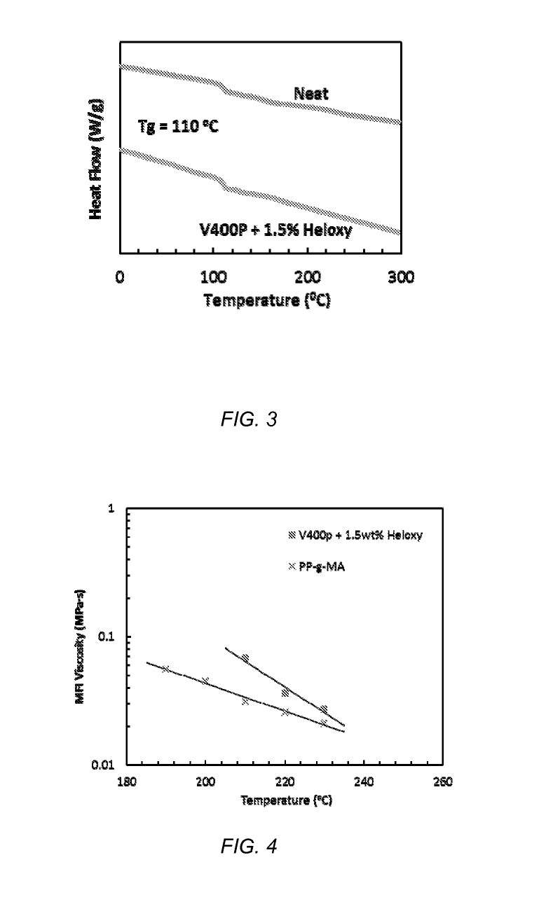

DSC thermograms of Vectra V400p compounded with 0 wt % and 1.5 wt % Heloxy 67 taken upon second heating at a rate of 5° C./min are shown in FIG. 3. As shown in the FIG. 3, the glass-to-liquid crystal transition temperature of the V400p samples is around 110° C. which is consistent with the glass transition temperature reported before, indicating that the thermophysical behavior of the V400p samples is not affected after reacting with Heloxy 67.

The modified Vectra V400p samples were placed into a film extruder to make LCP multilayer films. The other polymer component was polypropylene-graft-maleic anhydride (PP-g-MA; Orevac 18729) and the processing temperature window was 220-230° C. since viscosities of the two components are closely matched within this temperature range. FIG. 4 depicts the Melt Flow Index (MFI) viscosity (i.e., a viscosity derived from a melt flow index measurement) of modified Vectra V400p and PP-g-MA.

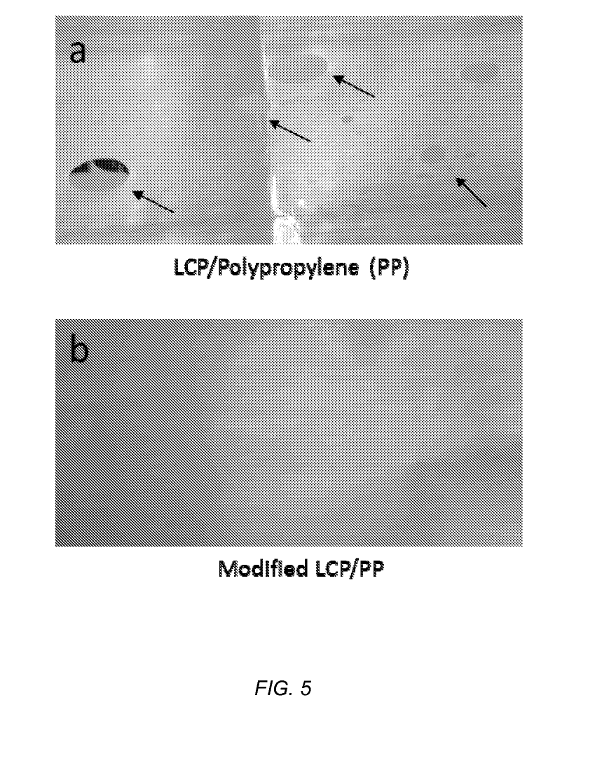

FIG. 5 shows photos of (a) neat Vectra V400p/PP-g-MA and (b) modified Vectra V400p/PP-g-MA multilayer films. Neat Vectra V400p multilayer films have many defects and holes due to the extremely low viscosity of the neat V400p. However, after modifying the viscosity of V400p, no obvious defects could be observed in the multilayer films.

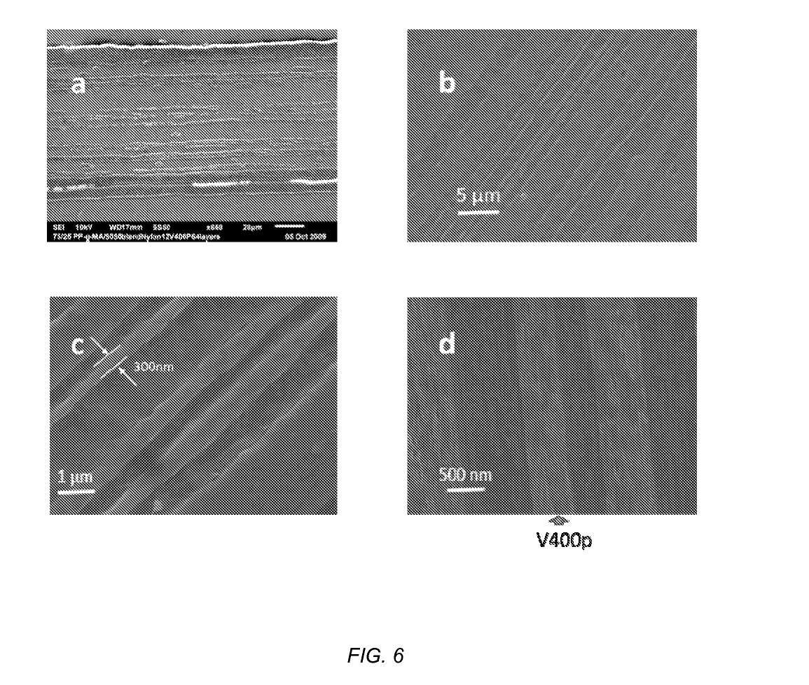

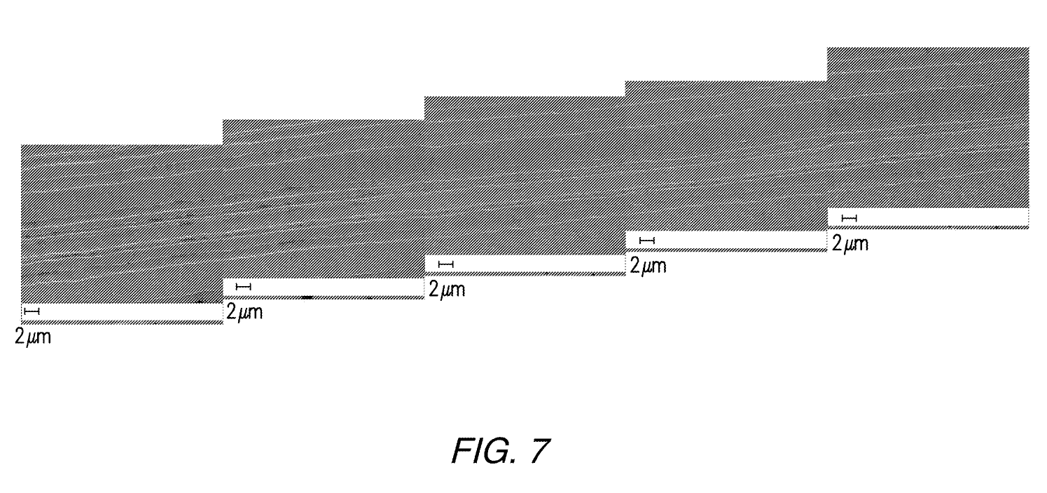

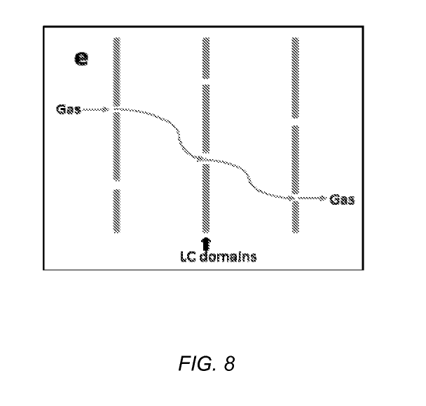

FIG. 6 depicts cross section SEM images of (a) neat Vectra V400p/PP-g-MA and (b, c, d) modified Vectra V400p/PP-g-MA multilayer films. FIG. 6A clearly indicates that the neat V400p layers break up due to the low viscosity of neat V400p and the mismatch of the viscosities. However, as shown in FIG. 6B, after the Heloxy modification, the V400p layers are continuous without a high density of break up defects in the multilayer structure, which indicates that the quality of the multilayer films are significantly improved. In addition, the higher magnification images reveal that the individual V400p layer thicknesses are as small as 300 nm (FIG. 6C). These thin submicron layers are an important aspect of the invention because LCP is expensive compared to conventional polymers. Therefore, one would like to use them as the thinnest layer possible to reduce overall cost of the barrier film. More interestingly, the morphology of the liquid crystal domains in the V400p layer is lamellar like and oriented in the extrusion direction (FIG. 6D), which was found to be helpful in enhancing the transport properties of LCP multilayer films. FIG. 7 depicts consecutive SEM images of multilayer films showing the continuity of LCP layers over large distances. Each image is roughly 30 microns wide. FIG. 8 depicts a schematic diagram showing the gas diffusion pathway through the oriented liquid crystal (LC) domains.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A compound comprising a liquid crystal polymer which has been reacted with an epoxy containing compound such that the compound comprises at least one modified rheological property relative to the unreacted liquid crystal polymer.

2. The compound of claim 1, wherein the liquid crystal polymer is a thermotropic liquid crystal polymer.

3. The compound of claim 1, wherein the epoxy containing compound comprises at least two epoxy functional groups.

4. The compound of claim 1, wherein the liquid crystal polymer is a poly (hydroxybenzoate-hydroxynaphthoate) copolymer.

5. The compound of claim 1, wherein the liquid crystal polymer is a poly (paraphenylene terephthalamide).

6. The compound of claim 1, wherein the epoxy containing compound is a diepoxy compound.

7. The compound of claim 1, wherein the epoxy containing compound is an aliphatic glycidyl ether diepoxy compound.

8. The compound of claim 1, wherein the epoxy containing compound increases the viscosity of the liquid crystal polymer without substantially altering the liquid crystal properties of the liquid crystal polymer.

9. A polymer composite comprising the compound of claim 1 and a thermoplastic polymer.

10. The polymer composite of claim 9, wherein the thermoplastic polymer is a polypropylene polymer.

11. The polymer composite of claim 9, wherein the polymer composite comprises multiple layers of thermoplastic polymer and the liquid crystal polymer compound.

12. A method of making a liquid crystalline polymer compound with at least one modified rheological property, comprising:
forming a mixture of a liquid crystal polymer with an epoxy containing compound; and
heating the mixture to a temperature at or above the glass transition temperature and/or the melt transition temperature of the liquid crystal polymer.

13. The method of claim 12, wherein the mixture is heated in an extrusion device and wherein the mixture is extruded after heating the mixture.

14. The method of claim 12, wherein the extruded mixture is formed into pellets.

15. The method of claim 12, wherein the mixture is dried under vacuum after heating the mixture.

16. The method of claim 12, further comprising:
heating a thermoplastic polymer at or above the glass transition temperature and/or the melt transition temperature of the thermoplastic polymer; and
co-extruding the heated compound and the heated thermoplastic polymer.

17. The method of claim 16, wherein the heated compound and the heated thermoplastic polymer are co-extruded as a film.

18. The method of claim 16, wherein the heated compound and the heated thermoplastic polymer are co-extruded as a laminar film comprising layers of the thermoplastic polymer and layers of the compound.

19. The method of claim 16, wherein the thermoplastic polymer and the compound have a similar viscosity at the processing temperature.

20. A compound comprising a liquid crystal polymer which has been reacted with an epoxy containing compound.
